(19) United States
(12) Patent Application Publication
(10) Pub. No.: US 2009/0116680 A1
(43) Pub. Date: May 7, 2009

(54) LOUDSPEAKER

(75) Inventor: Osamu Funahashi, Osaka (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd, Kadoma-shi, Osaka (JP)

(21) Appl. No.: 11/916,480

(22) PCT Filed: May 7, 2007
(86) PCT No.: PCT/JP2007/059450

§ 371 Date: Dec. 4, 2007

(30) Foreign Application Priority Data
May 10, 2006 (JP) 2006-131332
May 10, 2006 (JP) 2006-131333

(51) Int. Cl. H04R 9/06

(52) U.S. Cl. 381/400

(57) ABSTRACT

Loudspeaker has frame, magnetic circuit, voice coil, diaphragm, first combination and second combination. First combination and second combination are both provided closer to magnetic circuit than diaphragm, the inner rims of which are connected to voice coil while the outer rims are to frame. First combination has first damper and first edge wherein first edge has first edge protrusion protruding in a direction toward diaphragm. Second combination has second damper and second edge wherein second edge has second edge protrusion protruding in an opposite direction to the protruding direction of first edge protrusion. This structure obtains loudspeaker that distortion is suppressed and weight reduction is easy for an excursion part thus improved in driving efficiency.

### TECHNICAL FIELD

The present invention relates to a loudspeaker for use on various electronic appliances.

### BACKGROUND ART

The conventional loudspeaker 100 has a magnetic circuit 101, a voice coil 102, a diaphragm 103 and a frame 105, as shown in FIG. 12. The voice coil 102 is arranged movable relative to the magnetic gap provided over the magnetic circuit 101 and connected to an inner rim of the diaphragm 103. The diaphragm 103 has an outer rim connected to the frame 105 via a diaphragm edge 104. Furthermore, diaphragm 103 has a rear surface connected to the frame 105 via a suspension holder 106 and an edge 107. By providing the protrusion form of diaphragm edge 104 and the protrusion form of edge 107 in opposite direction, the vertical excursion of diaphragm 103 is given symmetric with respect to the vertical. This reduces distortion of loudspeaker 100.

Such a conventional loudspeaker 100 is disclosed in Japanese Patent Unexamined Publication No. 2004-7332 (patent document 1), for example.

Patent Document 1: Japanese Patent Unexamined Publication No. 2004-7332

### SUMMARY OF THE INVENTION

The present invention provides a loudspeaker which has a low distortion characteristic and a high driving efficiency.

A loudspeaker in the invention has a frame, a magnetic circuit, a voice coil, a diaphragm, a first combination and a second combination. The magnetic circuit, supported by the frame, is to form a magnetic gap. The voice coil is arranged movable relative to the magnetic gap. The diaphragm has an outer rim connected to the frame via a diaphragm edge and an inner rim connected to the voice coil. The first and second combinations are both provided closer to the magnetic circuit than the diaphragm, thus having an inner rim connected to the voice coil and an outer rim connected to the frame. Furthermore, the first combination has a first damper and a first edge while the second combination has a second damper and a second edge. The first edge has a first edge protrusion protruding in a direction toward the diaphragm or in a direction opposite to the diaphragm. The second edge has a second edge protrusion protruding in a direction opposite to the protruding direction of the first edge protrusion. By this structure, a loudspeaker is obtained which is to suppress the distortion in the sound the loudspeaker generates, easy to reduce the weight of the excursion part thereof, and improved in driving efficiency.

### BRIEF DESCRIPTION OF THE DRAWINGS

FIG. 1 is a sectional view of a loudspeaker according to embodiment 1 of the present invention.

FIG. 2 is an essential-part magnifying sectional view of the loudspeaker shown in FIG. 1.

FIG. 3 is an essential-part magnifying sectional view of a loudspeaker according to another example of embodiment 1 of the invention.

FIG. 4 is a sectional view of a loudspeaker according to embodiment 2 of the invention.

FIG. 5 is a sectional view of a loudspeaker according to another example of embodiment 2 of the invention.

FIG. 6 is a sectional view of a loudspeaker according to still another example of embodiment 2 of the invention.

FIG. 7 is a sectional view of a loudspeaker according to embodiment 3 of the invention.

FIG. 8 is an essential-part magnifying sectional view of the loudspeaker shown in FIG. 7.

FIG. 9 is an essential-part magnifying sectional view of a loudspeaker according to another example of embodiment 31 of the invention.

FIG. 10 is a sectional view of a loudspeaker according to embodiment 4 of the invention.

FIG. 11 is an essential-part magnifying sectional view of the loudspeaker shown in FIG. 10.

FIG. 12 is a sectional view of a conventional loudspeaker.

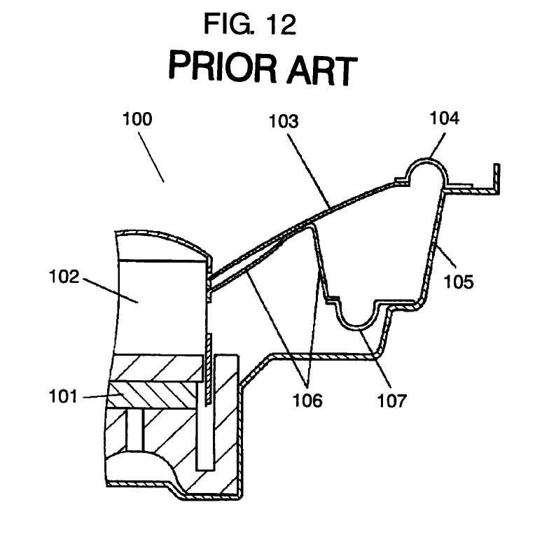

### REFERENCE MARKS IN THE DRAWINGS

1. Magnetic circuit

2. Voice coil

3. Diaphragm

4. Diaphragm edge

5. Frame

8. Magnetic gap

10a. First damper

10b. Second damper

10c. Third damper

10d. Fourth damper

11a, 11c. First edge

11b, 11d. Second edge

12a, 12c. First combination

12b, 12d. Second combination

20. Loudspeaker

21a, 21c. First edge protrusion

21b, 21d. Second edge protrusion

21e. Third edge protrusion

21f. Fourth edge protrusion

22a. Third protrusion

22b. Fourth protrusion

23a, 23b. Connection

31. Spacer

### DETAILED DESCRIPTION OF THE PREFERRED EMBODIMENTS

With using the drawings, embodiments of the present invention will now be explained below.

### Embodiment 1

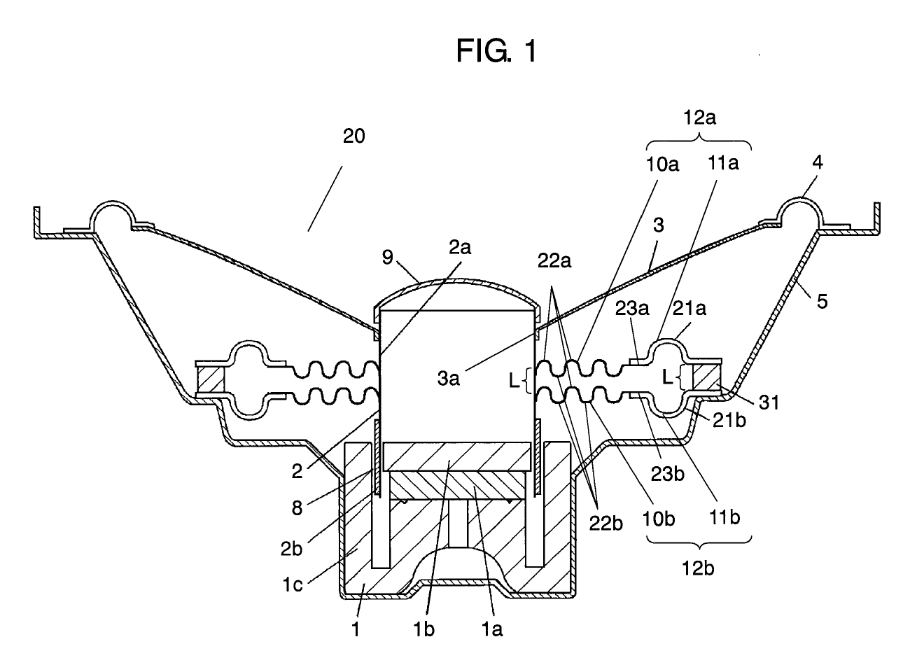

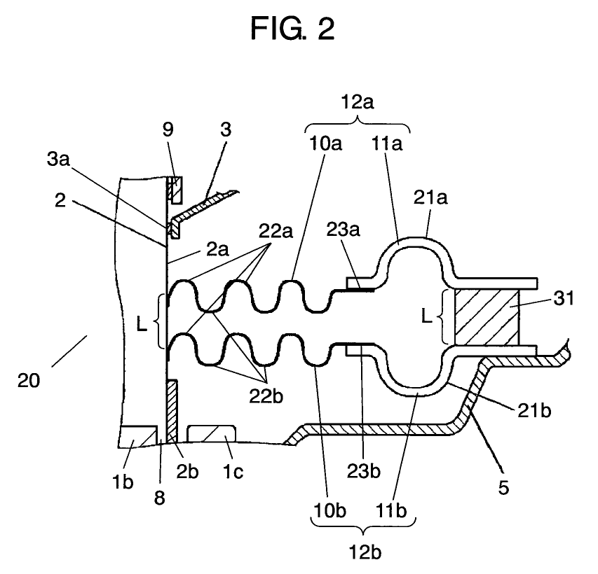

Embodiment 1 of the invention is explained below by using figures. FIG. 1 is a sectional view showing loudspeaker 20 according to embodiment 1 of the invention. FIG. 2 is an essential-part magnifying sectional view of loudspeaker 20 shown in FIG. 1. As shown in FIGS. 1 and 2, loudspeaker 20 has frame 5 in an inverted-cone form, magnetic circuit 1, voice coil 2 and diaphragm 3. Magnetic circuit 1 is arranged at a bottom center of frame 5. Furthermore, magnetic circuit 1 is formed by combining and bonding together disk-like magnet 1a, disk-like plate 1b and cylindrical yoke 1c. Magnetic gap 8 is formed between the inner rim surface of a sidewall of yoke 1c and the outer rim surface of plate 1b. Magnetic gap 8 has a cylindrical form opening to the above.

Voice coil 2 has cylindrical body 2a and coil 2b wound around the outer rim of body 2a. Voice coil 2 is connected, at its upper outer rim, with diaphragm 3 in a thin-dish form. Voice coil 2 is arranged movable vertically relative to magnetic gap 8. By the vertical operation of voice coil 2, diaphragm 3 is caused to vibrate. Incidentally, dust cap 9 is provided for dustproof, at the upper end of voice coil 2.

Diaphragm 3 is a sound generation source of loudspeaker 20. For this purpose, diaphragm 3 utilizes, as its main material, a pulp or a resin compatible with high hardness and internal loss. Diaphragm 3 has an outer rim connected to the opening end of frame 5 via diaphragm edge 4 (hereinafter, referred to as edge 4) protruding to the above. Meanwhile, diaphragm 3 has an inner rim bonded and fixed to the outer rim of body 2a. Edge 4 is formed by use of a material of urethane foam resin, foam rubber, SBR rubber or cloth, in order not to apply a movable load to diaphragm 3.

First damper 10a (hereinafter, referred to as damper 10a) and second damper 10b (hereinafter, referred to as damper 10b) are connected to an outer rim side of body 2a, as shown in FIGS. 1 and 2. Dampers 10a, 10b are connected to body 2a, in respective positions closer to magnetic circuit 1 than fixing region 3a of diaphragm 3. Damper 10a pand damper 10b are connected to body 2a, with predetermined spacing L. Damper 10a has an outer rim connected to frame 5 via first edge 11a (hereinafter, referred to as edge 11a) separate from the damper 10a. Likewise, damper 10b has an outer rim connected to frame 5 via second edge 11b (hereinafter, referred to as edge 11b) separate from the damper 10b. Damper 10a and edge 11a constitute first combination 12a (hereinafter, referred to as combination 12a). Likewise, damper 10b and edge 11b constitute second combination 12b (hereinafter, referred to as combination 12b). Edge 11a and edge 11b are fixed on the frame 5, in a state integrated together via spacer 31. Spacer 31 has a height dimension L so that edge 11a and edge 11b can be fixed on frame 5 with predetermined distance L of spacing. The spacing between dampers 10a and 10b and the spacing between edges 11a and 11b are both structured with the predetermined distance L of spacing. However, the spacing between dampers 10a and 10b and the spacing between edges 11a and 11b are not necessarily limited to the equal spacing. Those may be determined by taking account of the forms of dampers 10a, 10b, edges 11a, 11b, spacer 31 and so on.

Dampers 10a, 10b are of a corrugated ring-like structure. This provides a structure allowing for being flexible correspondingly to a vertical excursion of voice coil 2. Dampers 10a, 10b are formed using a material of urethane foam resin, foam rubber, SBR rubber or cloth, in order not to apply a large movable load to diaphragm 3, similarly to edge 4.

Edge 11a has first edge protrusion 21a (hereinafter, referred to as protrusion 21a) semicircular in section that protrudes toward diaphragm 3. Likewise, edge 11b has second edge protrusion 21b (hereinafter, referred to as protrusion 21b) semicircular in section that protrudes oppositely to diaphragm 3. Edges 11a, 11b are formed using a material of urethane foam resin, foam rubber, SBR rubber or cloth, in order not to apply a large movable load to diaphragm 3.

Comparing between Young's modulus E0 of edge 4, Young's modulus E1 of edge 11a and Young's modulus E2 of edge 11b, it is preferred that Young's modulus E0 of edge 4 is the smallest, Young's modulus E1 of edge 11a is the next smallest and Young's modulus E2 of edge 11b is the greatest. Namely, it is preferred that the relationship E0<E1<E2 is satisfied wherein edge 4 is the softest, next, edge 11a is softer and edge 11b is the hardest. The reason of this will be detailed later. Incidentally, for example, by forming edges 4, 11a, 11b by using urethane resin, foam urethane resin or foam rubber and edge 11b by using rubber material, the condition E0<E1<E2 is to be obtained.

Loudspeaker 20, when inputted an audio signal to coil 2b, reacts with the magnetic field formed in magnetic gap 8 so that voice coil 2 operates in the vertical direction. By the operation of the voice coil 2, diaphragm 3 is vibrated to generate sound from loudspeaker 20. Particularly, by the provision of edges 11a, 11b at outer rims of dampers 10a, 10b, the sound generated by loudspeaker 20 is suppressed from distorting, further enhancing the driving efficiency of loudspeaker 20.

Usually, the inner and outer rims of dampers 10a, 10b are connected to voice coil 2 and frame 5, thus having the purpose of suppressing the rolling occurring upon operation of voice coil 2. Accordingly, dampers 10a, 10b having a corrugated ring-like structure is given with elasticity in order to easily follow up the operation of voice coil 2. By the dampers 10a, 10b having the corrugated ring-like structure, the operation of voice coil 2 less undergoes a significant load at a small excursion of voice coil 2. However, as the excursion of voice coil 2 increases, the load of dampers 10a, 10b increases on the operation of voice coil 2.

Consequently, in loudspeaker 20 according to embodiment 1, combination 12a has damper 10a and edge 11a while combination 12b has damper 10b and edge 11b. Furthermore, damper 10a at its outer rim is connected to frame 5 via edge 11a. Likewise, damper 10b at its outer rim is connected to frame 5 via edge 11b. This increases the excursion of voice coil 2, to apply a stress to edges 11a, 11b when damper 10a, 10b exerts load to voice coil 2 or so. For this reason, protrusion 21a of edge 11a elastically deforms in accordance with the stress applied to edge 11a. Likewise, protrusion 21b of edge 11b elastically deforms in accordance with the stress applied to edge 11b. Owing to the semicircular sectional form of protrusions 21a, 21b, edges 11a, 11b are smooth in its elastic deformation to smoothly absorb the stress applied to edges 11a, 11b. Incidentally, loudspeaker 20 shown in FIGS. 1 and 2 has protrusions 21a, 21b that are semicircular in sectional form. However, the sectional form of protrusion 21a, 21b is not limited to semicircular form. Namely, provided that the form allows the stress applied to edge 11a, 11b to concentrate at protrusion 21a, 21b and smoothly elastically deform edge 11a, 11b, acute-angled protrusion in section or elliptic protrusion (not shown), for example, is applicable.

Therefore, even when voice coil 2 has an increasing excursion, the excursion of voice coil 2 is less hindered by the presence of dampers 10a, 10b and edges 11a, 11b. As a result, the driving efficiency of loudspeaker 20 is suppressed from lowering.

In embodiment 1, voice coil 2 is vertically held by three supports of edge 4, combination 12a and combination 12b. In order to enhance the driving efficiency of the driver 20, edge 4 greatest in plane shape is thin-walled to reduce the weight of the excursion part including diaphragm 3, edge 4 and the like. This reduces the weight of diaphragm 3 and the weight of edge 4, to enhance the driving efficiency of loudspeaker 20. Meanwhile, where edge 4 is thin-walled, the support strength of voice coil 2 lowers. For this reason, edge 11a and edge 11b are structured thick-walled rather than edge 4. This compensates for the lowering the support strength of voice coil 2. Namely, Young's modulus Ea of combination 12a and Young's modulus Eb of combination 12b are greater than Young's modulus E0 of edge 4. Namely, the relationship E0<Ea and E0<Eb is satisfied, wherein combinations 12a, 12b are harder than edge 4.

In loudspeaker 20 thus structured, supporting voice coil 2 is dominated by the support of combinations 12a, 12b. Accordingly, diaphragm 3 is effectively suppressed from distorting in its vertical excursion by placing the vertical load on combination 12a and the vertical load on combination 12b in an equal state to a possible extent.

Now explanation is made on a structure that the vertical load on combination 12a and the vertical load on combination 12b are substantially equal in state.

Incidentally, dampers 10a, 10b are of a corrugated ring-like structure, each of which has a plurality of third protrusions 22a protruding toward diaphragm 3 and fourth protrusions 22b protruding oppositely to third protrusions 22a. Accordingly, dampers 10a, 10b basically have substantially equal vertical loads.

At first, explanation is made on edge 11b form. As shown in FIG. 2, edge 11b has protrusion 21b protruding to the below. Namely, protrusion 21b is in a form protruding opposite to diaphragm 3. Furthermore, protrusion 21b has substantially a semicircular form in section. This allows edge 11b to readily deform to the below in FIG. 2, i.e. in a direction opposite to diaphragm 3. Conversely, edge 11b is not ready to deform in a direction to the above in FIG. 2, i.e. toward diaphragm 3.

Meanwhile, edge 11a is provided in order to absorb the difference of vertical deformability of edge 11b. The provision of edge 11a serves to absorb the characteristic ready to deform to the below, the difference in vertical load on edge 11b. For this reason, edge 11a has a form opposed to edge 11b.

Namely, as shown in FIG. 2, edge 11a has protrusion 21a that protrudes in a direction to the above in FIG. 2, i.e. toward diaphragm 3. Furthermore, protrusion 21a has substantially a semicircular form in section. This makes it easy to deform in the direction to the above in FIG. 2, i.e. toward diaphragm 3. Conversely, deformation is not easy in a direction to the below in FIG. 2, i.e. opposite to diaphragm 3. In this manner, protrusions 21a of edge 11a and protrusion 21b of edge 11b are oppositely arranged to each other with a substantial semicircular form in section. Due to this, the vertical load on edge 11a and vertical load on edge 11b are given substantially equal in the state of magnitude.

Further making a detail of edges 11a, 11b, Young's modulus E1 of edge 11a is somewhat smaller than Young's modulus E2 of edge 11b. Namely, edge 4 is in a form protruding to the above in FIG. 1, as shown in FIG. 1. Consequently, taking account of the load difference at edge 4, edge 11a is less hard as compared to edge 11b.

As mentioned above, edge 4 is light in weight by virtue of its small thickness. This reduces the weight of diaphragm 3 and the weight of edge 4, to raise the driving efficiency of loudspeaker 20. Consequently, load is not so great in vertical excursion of diaphragm 3. However, because edge 4 protrudes to the above in FIG. 1, edge 4 is ready to deform to the above and conversely not easy to deform to the below. This difference, although somewhat in degree, turns into a difference of vertical excursion load as to diaphragm 3. Relative to the vertical excursion load of diaphragm 3, loudspeaker 20 of the invention has Young's modulus E1 at edge 11a somewhat smaller than Young's modulus E2 at edge 11b, as noted before. Namely, edge 11a is less hard as compared to edge 11b. This adjusts the difference of vertical excursion load of diaphragm 3 into a substantially equal state.

In other words, in FIGS. 1 and 2, voice coil 2 is easier to move to the above in FIG. 1 and the upper in FIG. 2 as compared to the excursion to the below because of the reason resulting from the forms of edge 4 and edge 11a. Furthermore, by the reason resulting from the form of edge 11b, downward excursion is easier as compared to upward excursion. From this fact, the easiness of excursion is taken into account on the assumption that edge 11a and edge 4 are in a pair for one edge 11b. By this fact, Young's modulus E1 of edge 11a is somewhat smaller than Young's modulus E2 of edge 11b. As a result, the vertical excursion of diaphragm 3 is given substantially symmetric with respect to the vertical, thus reducing distortions in loudspeaker 20. Furthermore, because edge 4 greatest in plane shape is weight-reduced, the excursion part of loudspeaker 20 can be easily reduced in weight. Thus, loudspeaker 20 having high driving efficiency is obtainable for loudspeaker 20 for reproducing middle and higher ranges of sound.

In the structure that dampers 10a, 10b are connected to frame 5 via edges 11a, 11b, the power linearity due to dampers 10a, 10b is ensured linear before the excursion of voice coil 2 increases to a certain extent. In the case the excursion of voice coil 2 becomes a predetermined width or greater and linearity becomes difficult to obtain, linearity is complemented for by the elasticity of edges 11a, 11b. Accordingly, the total Young's modulus of edges 11a, 11b are desirably greater than the total Young's modulus of dampers 10a, 10b. Namely, edges 11a, 11b are desirably harder than dampers 10a, 10b.

Meanwhile, damper 10a and edge 11a are desirably set with different Young's moduli from each other so that the both can function independently in accordance with the excursion of voice coil 2. By establishing the Young's modulus of between damper 10a and edge 11a, i.e. at connection 23a of damper 10a and edge 11a, greater than the Young's modulus of damper 10a and greater than the Young's modulus of edge 11a, independence of damper 10a and edge 11a is ensured for damper 10a and edge 11a. Namely, connection 23a is desirably harder than damper 10a and than edge 11a.

Likewise, damper 10b and edge 11b are desirably set with different Young's moduli from each other so that the both can function independently in accordance with the excursion of voice coil 2. By establishing the Young's modulus of between damper 10b and edge 11b, i.e. at connection 23b of damper 10b and edge 11b, greater than the Young's modulus of damper 10b and greater than the Young's modulus of edge 11b, independence of damper 10a and edge 11a is ensured for damper 10b and edge 11b. Namely, connection 23b is desirably harder than damper 10b and than edge 11b.

In order to establish the Young's modulus of connection 23a greater than the Young's modulus of damper 10a and than the Young's modulus of edge 11a, it is preferable to use a hard adhesive, say, based on acryl as an adhesive type for bonding between edge 11a and damper 10a. If reinforcing material (not shown) is pasted on connection 23a, the Young's modulus of connection 23a can be easily increased. Likewise, in order to establish the Young's modulus of connection 23b greater than the Young's modulus of damper 10b and than the Young's modulus of edge 11b, it is preferable to use a hard adhesive, say, based on acryl as an adhesive type for bonding between edge 11b and damper 10b. If reinforcing material (not shown) is pasted on connection 23b, the Young's modulus of connection 23a can be easily increased.

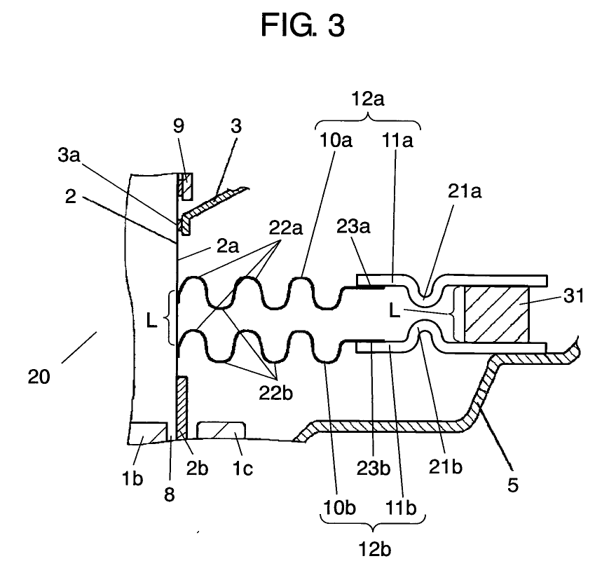

FIG. 3 is an essential-part magnifying sectional view showing another example of loudspeaker 20 according to embodiment 1 of the invention. Loudspeaker 20 shown in FIG. 3 is different in edge 11a, 11b structure, i.e. combination 12a, 12b structure, from loudspeaker 20 shown in FIGS. 1 and 2, wherein the other elements are same in structure.

Namely, loudspeaker 20 shown in FIG. 3 has a structure that protrusion 21a of edge 11a protrudes in a direction opposite to diaphragm 3 while protrusion 21b of edge 11b protrudes in a direction toward diaphragm 3. Damper 10a and edge 11a constitute first combination 12a while damper 10b and edge 11b constitute second combination 12b. Edge 11a and edge 11b are fixed on frame 5, in a state integrated via spacer 31.

With loudspeaker shown in FIG. 3, loudspeaker 20 is provided that the sound generated by loudspeaker 20 is suppressed against distortions wherein driving efficiency of loudspeaker 20 is enhanced. Besides, loudspeaker 20 having high driving efficiency is obtainable for loudspeaker 20 for reproducing middle and higher ranges of sound because of loudspeaker 20 excursion part is easily weight-reduced.

### Embodiment 2

Embodiment 2 of the invention is explained below by using figures. Note that similar reference character is attached to the similar structure to embodiment 1, to omit the detailed explanation thereof.

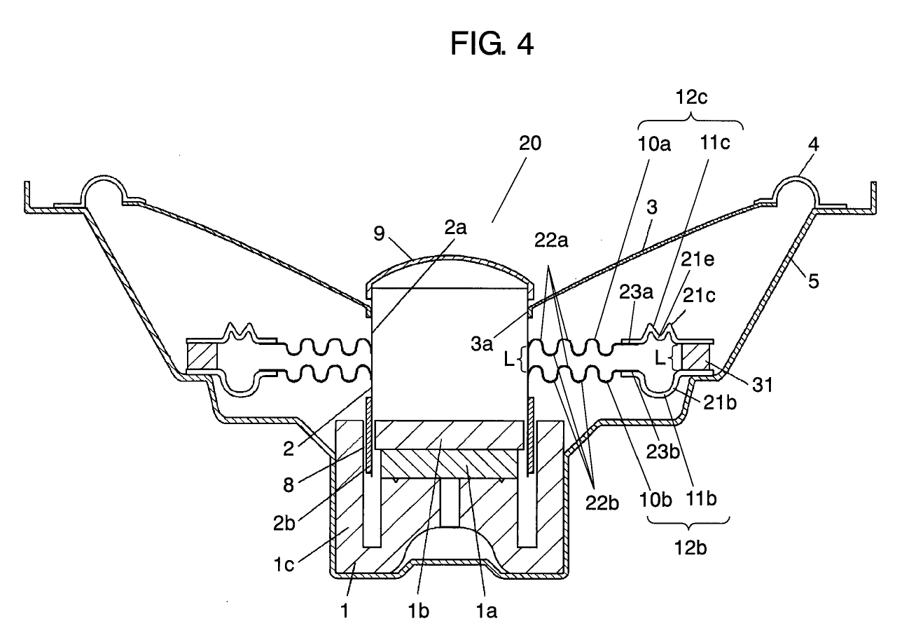

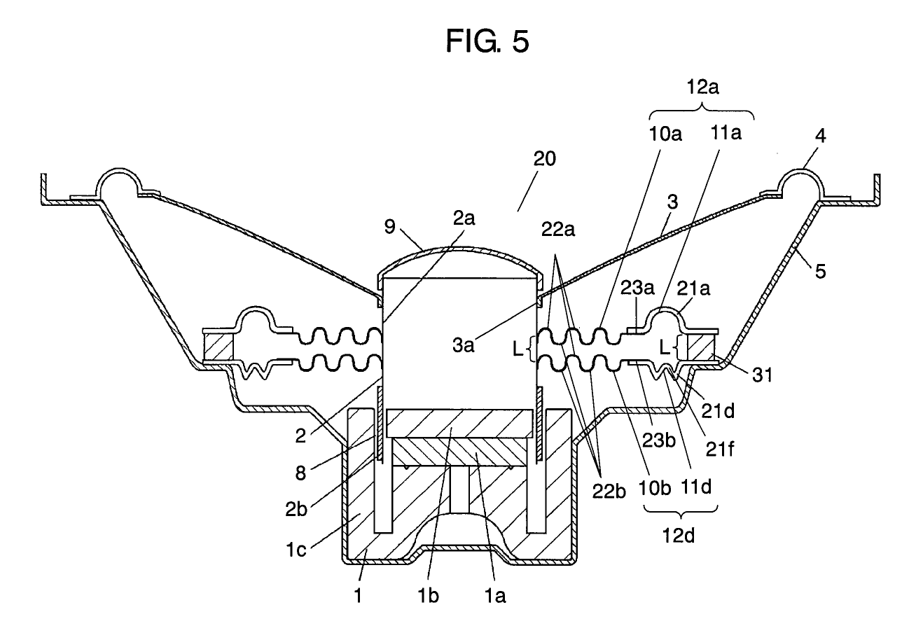

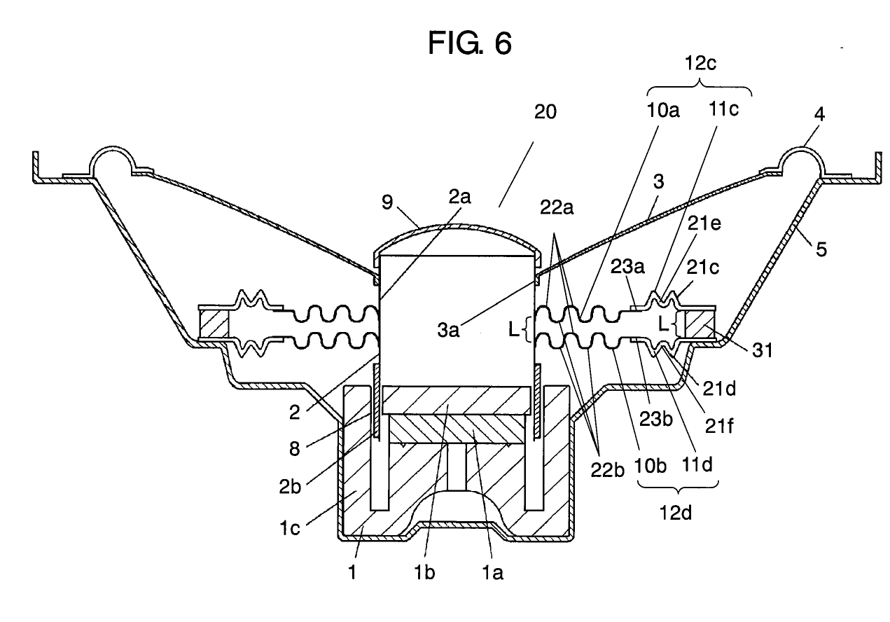

FIG. 4 is a sectional view showing loudspeaker 20 according to embodiment 2 of the invention. FIG. 5 is a sectional view showing another example of loudspeaker 20 according to embodiment 2 of the invention. FIG. 6 is a sectional view showing another example of loudspeaker 20 according to embodiment 2 of the invention. Loudspeaker 20 of embodiment 2 is different from loudspeaker 20 of embodiment 1 in respect of edge 11a, 11b structure, i.e. combination 12a, 12b structure, wherein the other elements are same in structure as embodiment 1.

First of all, loudspeaker 20 shown in FIG. 4 is provided with first edge 11c (hereinafter, referred to as edge 11c) in place of edge 11a of loudspeaker 20 of embodiment 1. Edge 11c has two first edge protrusions 21c (hereinafter, referred to as protrusions 21c) and one third edge protrusion 21e (hereinafter, referred to as protrusion 21e), thereby having a corrugated sectional form. Protrusion 21c protrudes in a direction toward diaphragm 3 while protrusion 21e protrudes in a direction opposite to diaphragm 3. Edge 11c is formed by use of a material of urethane foam resin, foam rubber, SBR rubber or cloth, in order not to apply a large movable load to diaphragm 3. Damper 10a and edge 11c constitute first combination 12c. Edge 11c and edge 11b are fixed on frame 5, in a state integrated together via spacer 31.

As shown in FIG. 4, edge 11c has two protrusions 21c protruding toward above in FIG. 4, i.e. in a direction toward diaphragm 3, and one protrusion 21e protruding in a direction opposite to diaphragm 3. Due to this, deformation readily occurs in the direction toward above in FIG. 4, i.e. toward diaphragm 3. Conversely, deformation does not readily occur in the direction toward below in FIG. 4, i.e. opposite to diaphragm 3. Consequently, by combining edge 11b and edge 11c in a manner as shown in FIG. 4, the magnitude of a vertical load on edge 11b and the magnitude of a vertical load on edge 11c are given substantially equal in state.

Furthermore, Young's modulus E1 of edge 11c is somewhat smaller as compared to Young's modulus E2 of edge 11b. Namely, edge 11c is somewhat less hard as compared to edge 11b. The reason Young's modulus E1 of edge 11c is somewhat smaller as compared to Young's modulus E2 of edge 11b is similar to the reason Young's modulus E1 of edge 11a is somewhat smaller as compared to Young's modulus E2 of edge 11b as was explained in embodiment 1. Accordingly, explanation in detail is omitted.

In loudspeaker 20 shown in FIG. 4, the vertical excursion of diaphragm 3 is given substantially symmetric with respect to the vertical, which reduces distortion of loudspeaker 20. Furthermore, because edge 4 greatest in plane shape is thin-walled and weight-reduced, the excursion part of loudspeaker 20 is easily weight-reduced. Thus, loudspeaker 20 having high driving efficiency is obtainable for loudspeaker 20 for reproducing middle and higher ranges of sound.

Loudspeaker 20 shown in FIG. 5 is provided with second edge 11d (hereinafter, referred to as edge 11d) in place of edge 11b of loudspeaker 20 of embodiment 1. Edge 11d has two second edge protrusions 21d (hereinafter, referred to as protrusions 21d) and one fourth edge protrusion 21f (hereinafter referred to as protrusion 21f), thereby having a corrugated sectional form. Protrusion 21f protrudes in a direction toward diaphragm 3 while protrusion 21d protrudes in a direction opposite to diaphragm 3. Edge 11d is formed by use of a material of urethane foam resin, foam rubber, SBR rubber or cloth, in order not to apply a large movable load to diaphragm 3. Damper 10b and edge 11d constitute second combination 12d. Edge 11a and edge 11d are fixed on the frame 5, in a state integrated together via spacer 31.

As shown in FIG. 5, edge 11d has one protrusion 21f protruding toward above in FIG. 5, i.e. in a direction toward diaphragm 3, and two protrusions 21d protruding below in FIG. 5, i.e. in a direction opposite to diaphragm 3. Due to this, deformation readily occurs in the direction toward below in FIG. 5, i.e. opposite to diaphragm 3. Conversely, deformation does not readily occur in the direction toward above in FIG. 5, i.e. toward diaphragm 3. Consequently, by combining edge 11a and edge 11d in a manner as shown in FIG. 5, the magnitude of a vertical load on edge 11a and the magnitude of a vertical load on edge 11d are given substantially equal in state.

Furthermore, Young's modulus E1 of edge 11a is somewhat smaller as compared to Young's modulus E2 of edge 11d. Namely, edge 11a is somewhat less hard as compared to edge 11d. The reason Young's modulus E1 of edge 11a is somewhat smaller as compared to Young's modulus E2 of edge 11d is similar to the reason Young's modulus E1 of edge 11a is somewhat smaller as compared to Young's modulus E2 of edge 11b as was explained in embodiment 1. Accordingly, explanation in detail is omitted.

In loudspeaker 20 shown in FIG. 5, the vertical excursion of diaphragm 3 is given substantially symmetric with respect to the vertical, which reduces distortions in loudspeaker 20. Furthermore, because edge 4 greatest in plane shape is thin-walled and weight-reduced, the excursion part of loudspeaker 20 is easily weight-reduced. Thus, loudspeaker 20 having high driving efficiency is obtainable for loudspeaker 20 for reproducing middle and higher ranges of sound.

Loudspeaker 20 shown in FIG. 6 is provided with edges 11c, 11d in place of edges 11a, 11b of loudspeaker 20 of embodiment 1. Damper 10a and edge 11c constitute first combination 12c. Likewise, damper 10b and edge 11d constitute second combination 12d. Edge 11c and edge 11d are fixed on frame 5, in a state integrated together via spacer 31.

As shown in FIG. 6, edge 11d has one protrusion 21f protruding in a direction toward diaphragm 3 and two protrusions 21d protruding in a direction opposite to diaphragm 3. Due to this, deformation readily occurs in the direction opposite to diaphragm 3, and conversely deformation does not readily occur in the direction toward diaphragm 3. Meanwhile, edge 11c has two protrusions 21c protruding in a direction toward diaphragm 3 and one protrusion 21e protruding in a direction opposite to diaphragm 3. Due to this, deformation readily occurs in the direction toward diaphragm 3, and conversely deformation does not readily occur in the direction opposite to diaphragm 3. Due to this, by combining edge 11c and edge 11d as shown in FIG. 6, the magnitude of vertical load on edge 11c and the magnitude of vertical load on edge 11d are given substantially equal in state.

Young's modulus E1 of edge 11c is somewhat smaller as compared to Young's modulus E2 of edge 11d. Namely, edge 11c is somewhat less hard as compared to edge 11d. The reason Young's modulus E1 of edge 11c is somewhat smaller as compared to Young's modulus E2 of edge 11d is similar to the reason Young's modulus E1 of edge 11a is somewhat smaller as compared to Young's modulus E2 of edge 11b as was explained in embodiment 1. Accordingly, explanation in detail is omitted.

In loudspeaker 20 shown in FIG. 6, the vertical excursion of diaphragm 3 is given substantially symmetric with respect to the vertical, which reduces distortion of loudspeaker 20. Furthermore, because edge 4 greatest in plane shape is thin-walled and weight-reduced, the excursion part of loudspeaker 20 is easily weight-reduced. Thus, loudspeaker 20 having high driving efficiency is obtainable for loudspeaker 20 for reproducing middle and higher ranges of sound.

### Embodiment 3

Embodiment 3 of the invention is explained below by use of figures. Note that similar reference character is attached to the similar structure to embodiment 1 or 2, to omit the detailed explanation thereof.

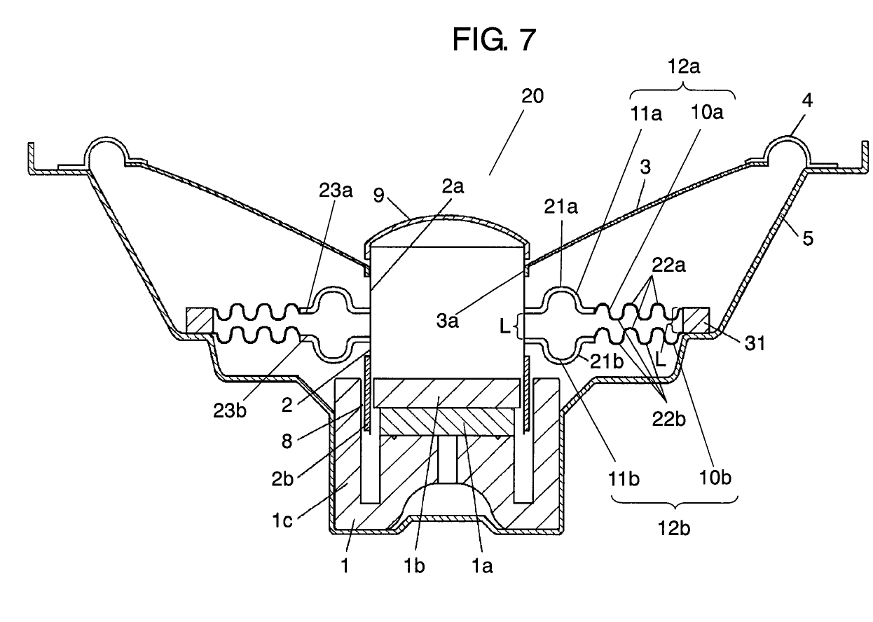

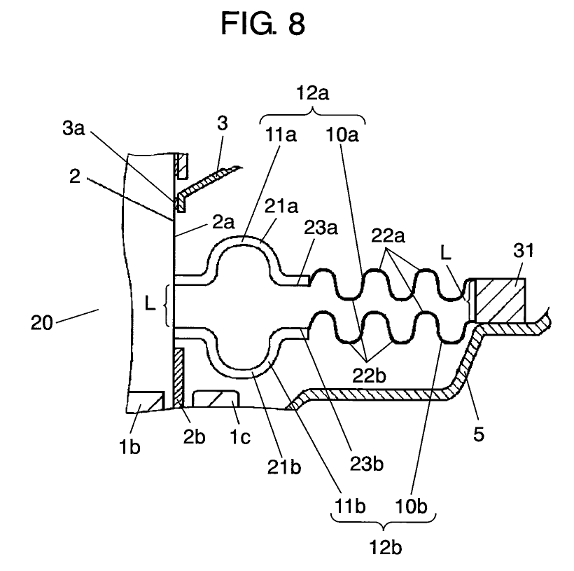

FIG. 7 is a sectional view showing loudspeaker 20 according to embodiment 3 of the invention. FIG. 8 is an essential-part magnifying view of loudspeaker 20 shown in FIG. 7. Loudspeaker 20 of embodiment 3 is different from loudspeaker 20 of embodiment 1 or 2 in respect of first combination 12a structure and second combination 12b structure, wherein the other elements are same in structure as embodiment 1 or 2.

Namely, damper 10a and damper 10b at their outer rims are fixed on frame 5, in a state integrated together via spacer 31, as shown in FIGS. 7 and 8. Spacer 31 has a height dimension L so that dampers 10a, 10b are fixed on frame 5 with predetermined distance L. Furthermore, damper 10a has an inner rim connected to an outer rim of main body 2a of voice coil 2 via edge 11a separate from damper 10a. Likewise, damper 10b has an inner rim connected to an outer rim of main body 2a of voice coil 2 via edge 11b separate from damper 10b. Edges 11a, 11b are connected on main body 2a in a position closer to the magnetic circuit 1 than fixing region 3a of diaphragm 3. Edge 11a and Edge 11b are connected on main body 2a, with predetermined distance L of spacing. Damper 10a and edge 11a constitutes first combination 12a. Likewise, damper 10b and edge 11b constitutes second combination 12b. The spacing between dampers 10a and 10b and the spacing between edges 11a and 11b are both structured with predetermined distance L of spacing. However, the spacing between dampers 10a and 10b and the spacing between edges 11a and 11b are not necessarily limited to the spacing equality. Those may be determined by taking account of the forms of dampers 10a, 10b, edges 11a, 11b, spacer 31 and so on.

In loudspeaker 20 of embodiment 3, when an audio signal is inputted to coil 2b, voice coil 2 operates vertically in response to a magnetic field formed in the magnetic gap 8 similarly to loudspeaker 20 of embodiment 1 or 2. By the operation of the voice coil 2, diaphragm 3 is vibrated to generate sound from loudspeaker 20. Particularly, by the provision of edges 11a, 11b at inner rims of dampers 10a, 10b, the sound generated by loudspeaker 20 is suppressed from distorting, further enhancing the driving efficiency of loudspeaker 20. Meanwhile, the excursion part of loudspeaker 20 is easily reduced in weight. Thus, loudspeaker 20 having high driving efficiency is obtainable for loudspeaker 20 for reproducing middle and higher ranges of sound.

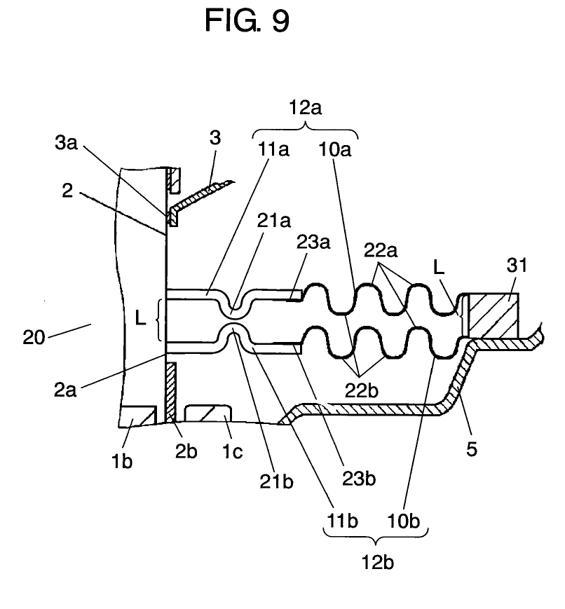

FIG. 9 is an essential-part magnifying sectional view showing another embodiment of loudspeaker 20 according to embodiment 3 of the invention. Loudspeaker 20 shown in FIG. 9 is different in edge 11a, 11b structure, i.e. combination 12a, 12b structure, from loudspeaker 20 shown in FIGS. 7 and 8, wherein the other elements are same in structure.

Namely, in loudspeaker 20 shown in FIG. 9, edge 11a has protrusion 21a that protrudes in a direction opposite to diaphragm 3 while edge 11b has protrusion 21b that protrudes in a direction toward diaphragm 3. Damper 10a and edge 11a constitutes first combination 12a while damper 10b and edge 11b constitutes second combination 12b. Damper 10a and damper 10b are fixed on the frame 5, in a state integrated together via spacer 31.

With loudspeaker shown in FIG. 9, loudspeaker 20 is provided that the sound generated by loudspeaker 20 is suppressed against distortions further with driving efficiency of loudspeaker 20 enhanced. Likewise, loudspeaker 20 with high driving efficiency is obtainable for loudspeaker 20 for reproducing middle and higher ranges of sound because of loudspeaker 20 excursion part is easily weight-reduced.

### Embodiment 4

Embodiment 4 of the invention is explained below by use of figures. Note that similar reference character is attached to the similar structure to embodiment 1, 2 or 3, to omit the detailed explanation thereof.

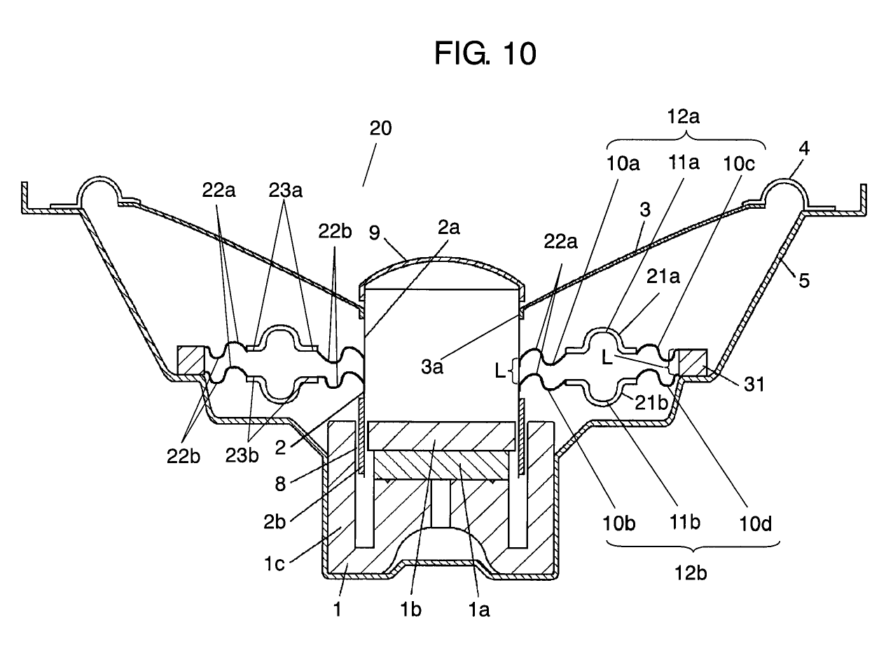

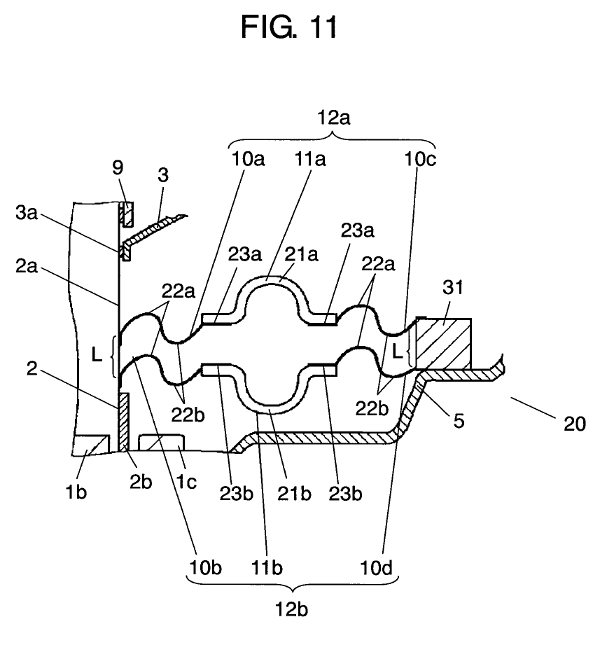

FIG. 10 is a sectional view showing loudspeaker 20 according to embodiment 4 of the invention. FIG. 11 is an essential-part magnifying view of loudspeaker 20 shown in FIG. 10. Loudspeaker 20 of embodiment 4 is different from loudspeaker 20 of embodiment 1, 2 or 3 in respect of first combination 12a structure and second combination 12b structure, wherein the other elements are same in structure as embodiment 1.

In loudspeaker 20 shown in FIGS. 10 and 11, third damper 10c (hereinafter, referred to as damper 10c) is inserted between the outer rim of edge 11a and frame 5 of loudspeaker 20 according to embodiment 1. Likewise, fourth damper 10d (hereinafter, referred to as damper 10c) is inserted between the outer rim of edge 11b and frame 5. Damper 10a, edge 11a and damper 10c constitute first combination 12a. Likewise, damper 10b, edge 11b and damper 10d constitute second combination 12b. Damper 10a and damper 10b are fixed on frame 5, in a state integrated together via spacer 31.

As shown in FIGS. 10 and 11, dampers 10c, 10d are of a corrugated ring-like structure similarly to dampers 10a, 10b. This provides a structure allowing for being flexible correspondingly to a vertical excursion of voice coil 2. Dampers 10c, 10d are formed using a material of urethane foam resin, foam rubber, SBR rubber or cloth, in order not to apply a large movable load to diaphragm 3, similarly to dampers 10a, 10b. Dampers 10c, 10d are each structured having, in plurality, third protrusion protruding 22a in a direction toward diaphragm 3 and fourth protrusion 22b protruding in a direction opposite to third protrusion 22a. Accordingly, basically, vertical load is substantially equal at dampers 10c, 10d. Due to this, loudspeaker 20 is identical in basic operation, function and effect to the foregoing embodiments 1, 2 and 3.

Accordingly, in loudspeaker 20 shown by embodiment 4, the vertical excursion of diaphragm 3 is substantially symmetric with respect to the vertical, thus reducing distortion at loudspeaker 20. Furthermore, edge 4 greatest in plane shape is thin-walled and weight-reduced thus reducing the weight of the excursion part of loudspeaker 20. Thus, loudspeaker 20 having high driving efficiency is obtainable for loudspeaker 20 for reproducing middle and higher ranges of sound.

### INDUSTRIAL APPLICABILITY

Distortion of the loudspeaker in the invention is reduced in the sound generated by the loudspeaker and improved in driving efficiency. This results in usefulness particularly for loudspeakers for middle and higher range applications.

1. A loudspeaker comprising:
a frame
a magnetic circuit supported by the frame and for forming a magnetic gap;
a voice coil arranged movable relative to the magnetic gap;
a diaphragm having an outer rim connected to the frame via a diaphragm edge and an inner rim connected to the voice coil;
a first combination provided closer to the magnetic circuit than the diaphragm and having a first damper and a first edge, thus having an inner rim connected to the voice coil and an outer rim connected to the frame; and
a second combination provided closer to the magnetic circuit than the diaphragm and having a second damper and a second edge, thus having an inner rim connected to the voice coil and an outer rim connected to the frame,
the first edge having a first edge protrusion protruding in a direction toward the diaphragm or in a direction opposite to the diaphragm, and
the second edge having a second edge protrusion protruding in a direction opposite to the protruding direction of the first edge protrusion.

2. The loudspeaker of claim 1, wherein the first damper and the second damper are both connected to the voice coil,
the first edge and the second edge being both connected to the frame.

3. The loudspeaker of claim 2, wherein the first combination has a third damper provided between the first edge and the frame,
the second combination having a fourth damper provided between the second edge and the frame.

4. The loudspeaker of claim 1, wherein the first damper and the second damper are both connected to the frame,
the first edge and the second edge being both connected to the voice coil.

5. The loudspeaker o f claim 1, wherein the first combination has a Young's modulus and the second combination has a Young's modulus that is greater than a Young's modulus of the diaphragm edge.

6. The loudspeaker of claim 5, wherein the first edge has a Young's modulus smaller than a Young's modulus of the second edge.

7. The loudspeaker of claim 5, wherein the first edge is formed by use of foam rubber while the second edge is formed by use of rubber material.

8. The loudspeaker of claim 7, wherein the diaphragm edge and the first edge are formed by use of foam urethane resin, the diaphragm edge having a Young's modulus smaller than a Young's modulus of the first edge.
